(19) United States
(12) Patent Application Publication
(10) Pub. No.: US 2008/0068596 A1
(43) Pub. Date: Mar. 20, 2008

(54) Sensor unit and optical sensor for a scanning device

(76) Inventor: Achim Kruck, Pfedlbach (DE)

Correspondence Address: MG-IP Law, PLLC, P.O. BOX 1364, FAIRFAX, VA, 22038-1364, US

(21) Appl. No.: 11/889,809

(22) Filed: Aug. 16, 2007

Related U.S. Application Data
(60) Provisional application No. 60/839,193, filed on Aug. 22, 2006.

(30) Foreign Application Priority Data
Aug. 16, 2006 (DE) DE 102006038302

(51) Int. Cl. G01J 1/00

(52) U.S. Cl. 356/213

(57) ABSTRACT

A sensor unit is provided that includes a light-sensitive semiconductor element, which has at least one light-sensitive area, disposed in particular beneath a light-transmitting cover layer, and a flat contacting unit, which is placed electrically conductive on contact areas of the semiconductor element and is provided with at least one recess, which is formed for incidence of light on the light-sensitive area. The invention that the sensor unit, particularly in the vicinity of the light-sensitive area, is made without a light-transmitting covering means.

This nonprovisional application claims priority to German Patent Application No. DE 102006038302, which was filed in Germany on Aug. 16, 2006, and to U.S. Provisional Application No. 60/839,193, which was filed on Aug. 17, 2006, and which are both herein incorporated by reference.

### BACKGROUND OF THE INVENTION

1. Field of the Invention

The present invention relates to a sensor unit comprising a light-sensitive semiconductor element, which has at least one light-sensitive area, disposed beneath a light-transmitting cover layer, and a flat contacting unit, which is placed electrically conductive on contact areas of the semiconductor element and is provided with at least one recess, which is formed for incidence of light onto the light-sensitive area, as well as an optical sensor for a scanning device of an optical data drive.

2. Description of the Background Art

U.S. Pat. No. 6,885,107 B1 discloses a sensor unit with a light-sensitive semiconductor element, in which electrical traces are placed on a contacting unit or printed circuit board or conductive film, electrically coupled to the semiconductor element. Contact areas of the semiconductor element for an electrical connection with the contacting unit and a light-sensitive area of the semiconductor element face the same surface of the semiconductor element. To enable the incidence of light on the semiconductor element, a recess is provided in the contacting unit. A form-stable and light-transmitting cover is applied to a contacting unit surface facing away from the semiconductor element to protect the semiconductor element on the light-sensitive front side from environmental effects. To assure low-loss lighting of the semiconductor element, the light-transmitting cover must be made of a material matched to the specified light wavelength. Moreover, the cover must maintain narrow tolerances with respect to its geometric construction to avoid undesirable deflection and scattering effects for the radiated light.

### SUMMARY OF THE INVENTION

It is therefore an object of the present invention to provide a sensor unit and an optical sensor for a scanning device of an optical data drive, in which more cost-effective manufacture and improved light radiation onto the semiconductor element are assured.

This object is attained according to a first aspect of the invention by a sensor unit of the aforementioned type, in which the sensor unit, particularly in the vicinity of the light-sensitive area, is made without a light-transmitting covering means. In contrast to the prior-art sensor unit, it is provided according to the invention to realize the sensor unit without additional light-transmitting covering means. This construction of the sensor unit is based on the realization that with a suitable selection of a layer structure for the semiconductor element, stable and reliable operation of the semiconductor element is possible without additional, light-transmitting covering means. The semiconductor element layer structure, which is mounted on a carrier structure or a substrate, has at least one light-sensitive layer area, which is provided to generate at least one light-dependent, electrical signal. The light-sensitive layer area is integrated into the layer structure in such a way that light rays incident upon a semiconductor element surface facing away from the carrier structure can be detected. The at least one contact area for deriving the at least one electrical signal is also formed on this semiconductor element surface.

The light-sensitive layer area can be disposed beneath a light-transmitting, i.e., optically transparent cover layer, which is formed on the same surface as the at least one contact area. The cover layer can be deposited preferably from a formless, particularly from a gaseous, phase firmly bonded on the layer structure even during the manufacture of a plurality of semiconductor elements, which are formed on a common carrier structure, a wafer, in a wafer process. This type of cover layer is thereby an integral component of the semiconductor element and can be applied under industrial process conditions, typical for the manufacture of semiconductor elements.

To assure that an advantageous incidence of light on the light-sensitive layer area can occur, the contacting unit in a vicinity adjacent to the light-sensitive layer area is provided with a recess, which enables the incidence of light through the contacting unit onto the light-sensitive area. Cost-effective manufacture of the sensor unit is made possible by dispensing with additional light-transmitting covering means. Process steps known from the prior art, such as the manufacture, quality testing, and application of light-transmitting covering means to the sensor unit, can be eliminated. Potential sources of defects, which can lead to the deterioration of the sensor unit up to its total failure, are eliminated by dispensing with the light-transmitting covering means.

Whereas the semiconductor element in the prior art can be enclosed in a small space volume, it is open in the construction of the sensor unit according to the invention. In this way, it can be avoided that material components, which emerge, are emitted as gases, or evaporate from the semiconductor element and/or from the contacting unit and/or from the electrical connections between the semiconductor element and contacting unit, particularly during the manufacturing process, deposit on the semiconductor element or on an inner surface of the cover and result in a deterioration of the detection properties of the semiconductor element. Therefore, the sensor unit of the invention can be made more cost-effectively and with improved optical detection properties.

An embodiment of the invention provides that the semiconductor element is formed without a housing. An especially compact structural form for the sensor unit can be realized thereby. The semiconductor element is placed directly with the form-stable layer structure, on whose surface the at least one contact area is formed, on the contacting unit and projects with its form-stable carrier structure from the contacting unit. Process steps and costs for the manufacture of the sensor unit can be eliminated by means of the housing-free construction of the semiconductor element. The dimensions of the sensor unit are substantially determined by the size of the semiconductor element and the contacting unit adjusted thereto. In an especially advantageous embodiment of the invention, the contacting unit is made in such a way that an area around the semiconductor element that is used for contacting of the contact areas, has at most a 50% greater surface than the largest surface of the semiconductor element. In other words, the area on which the semiconductor element lies is at most 50% greater than the surface with which the semiconductor element lies on the contacting unit. For this reason, the sensor unit with the housing-free semiconductor element can be integrated preferably into especially flat or slim optical sensors.

Another embodiment of the invention provides that the contacting unit can be made of an at least substantially non-light-transmitting material. Thereby, the edge of the recess of the contacting unit acts as a field stop for the light-sensitive semiconductor element. Light rays from spatial directions that do not match the light direction of the light ray to be detected are reflected or absorbed by the contacting unit and therefore do not reach the light-sensitive semiconductor element as undesirable stray radiation. Preferably, the contacting unit has a transmission for light wavelengths, relevant for the semiconductor element, of less than 50%, preferably of less than 25%, especially preferably of less than 15%.

Another embodiment of the invention provides that the contacting unit can have a thickness that is smaller than or the same as a thickness of the semiconductor element. This enables an especially compact construction of the sensor unit, which therefore can be mounted with the saving of space, for example, on an optical scanning device. A distance between optical components of the scanning device, such as in particular lenses or mirrors and the light-sensitive semiconductor element in the sensor unit of the invention is codetermined only unessentially by the thickness of the contacting unit. In an advantageous embodiment of the invention, the thickness of the contacting unit is less than 3/10 mm, preferably less than 2/10 mm, and the thickness of the semiconductor element is less than 5/10 mm, preferably less than 3/10 mm, especially preferably less than 2/10 mm. Thereby, a total thickness for the sensor unit of less than 1.5 mm, preferably less than 1 mm, may be realized including an electrical connection between the semiconductor element and the contacting unit.

It is provided in another embodiment of the invention that the contacting unit can be formed as a flexible printed circuit board, particularly made of a polyimide material. In the case of a flexible printed circuit board, it is possible to realize bending radii for the printed circuit board that are less than 50 times, preferably less than 15 times, the thickness of the printed circuit board. Thereby, an advantageous integration of the sensor unit into a compactly designed optical scanning device is possible. An electrical connection of the sensor unit occurs directly via the flexible printed circuit board, which can be built with small radii of curvature into the optical scanning unit. The use of polyimide material for the flexible printed circuit board enables, in addition to a small thickness for the printed circuit board, an especially advantageous flexibility and a small pitch grid for the traces and for the contact areas for electrical connection of the contact areas of the semiconductor element. Preferably, a pitch grid, therefore a spacing of traces and contact areas, of 0.25 mm to 0.3 mm between the contact areas of the semiconductor element with a printed circuit board made of polyimide material can be realized.

It is provided in a further embodiment of the invention that electrical connections between the semiconductor element and the contacting unit can be formed using flip-chip technology, particularly using solder ball technology. This enables an especially reliable and space-saving contacting between the semiconductor element and the contacting unit. To carry out flip-chip technology, the semiconductor element is placed with its contact areas on the contact areas of the contacting unit. It is preferably provided that the contact areas of the semiconductor element were provided with solder balls, particularly of lead-free tin solder, already during the manufacture of the semiconductor element. The solder balls are melted by application of heat during placement of the semiconductor element on the contacting unit and after cooling and solidification assure a reliable electrical connection between the semiconductor element and contacting unit. Alternatively, other connection techniques, such as the use of electrically conductive adhesive, welding of electrical connections, the use of friction-welded bonding wire studs (stud bumps), or pressure contacting by using shrinking adhesive can also be provided. It is assured with these methods that the semiconductor element is arranged in such a way that the light-sensitive area of the semiconductor element can be illuminated by incident light through the recess in the contacting unit.

In another embodiment of the invention, it is provided that the semiconductor element can be encapsulated on the side facing away from the light-sensitive area with a non-light-transmitting potting material with the contacting unit. As a result, a mechanical stabilization of the semiconductor element and the electrical contactings with the contacting unit is achieved. Moreover, the nor-light-transmitting potting material prevents that undesirable radiation of light can occur laterally to the light-sensitive area. Therefore, the precision of light detection by the light-sensitive semiconductor element is increased. An elastic or viscoplastic plastic compound, which is filled for nontransmission of light with an absorbing filler, particularly with soot particles, can preferably be used as the potting material.

In a further embodiment of the invention, it is provided that the semiconductor element can be provided with a particularly multilayered, preferably flat, antireflection coating, which is applied firmly bonded and is preferably matched to red, especially preferably to red and blue light waves. The use of the antireflection coating makes it possible to avoid that light radiated from the main direction of the incidence of light is reflected in an undesirable way at the surface of the semiconductor element and therefore is not available for detection of the light radiation. The antireflection coating can be made preferably multilayer to achieve an especially advantageous antireflection effect. In a layout of the sensor unit as a detector for an optical data drive, several light-sensitive areas arranged next to one another are provided in the semiconductor element. In this case, a central light-sensitive area is provided for the detection of a light ray reflected by an optical data carrier, whereas light-sensitive areas, arranged in the surrounding area, for determining optionally occurring position deviations are provided for the sensor unit. To enable a precise positioning of the sensor unit relative to the incident light ray based on the signals of the surrounding light-sensitive areas, the antireflection coating is made substantially flat, like an additionally or alternatively provided light-transmitting cover layer, i.e., almost approximates a plane in its surface contour. Because infrared and/or red and/or blue light waves in a wavelength range from 400 nm to 800 nm are used preferably for the scanning of optical data carriers, the antireflection coating is accordingly matched to such light wavelengths.

According to another aspect of the invention, an optical sensor can be provided for a scanning device of an optical data drive, in which a sensor unit is mounted. The optical sensor is realized on a carriage movable relative to an optical data carrier and comprises at least one laser light source, a semitransparent mirror, and the sensor unit according to the invention. It is provided in this case that light is emitted by the laser light source through the semitransparent mirror and is deflected at a reflection surface of the semitransparent mirror in the direction of the optical data carrier. The deflected light ray is reflected by the optical data carrier according to the data stored there and radiated onto the sensor unit during reflection with use of the semitransparent mirror. This type of optical sensor is used in particular in optical data drives such as compact disc drives (CD), digital-versatile-disc drives (DVD), and variations thereof.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective, schematic illustration of a sensor unit before mounting of the semiconductor element on the contacting unit,

FIG. 2 is the sensor unit according to FIG. 1 after mounting of the semiconductor element on the contacting unit, and

FIG. 3 is a schematic illustration of an optical sensor for an optical data drive.

### DETAILED DESCRIPTION

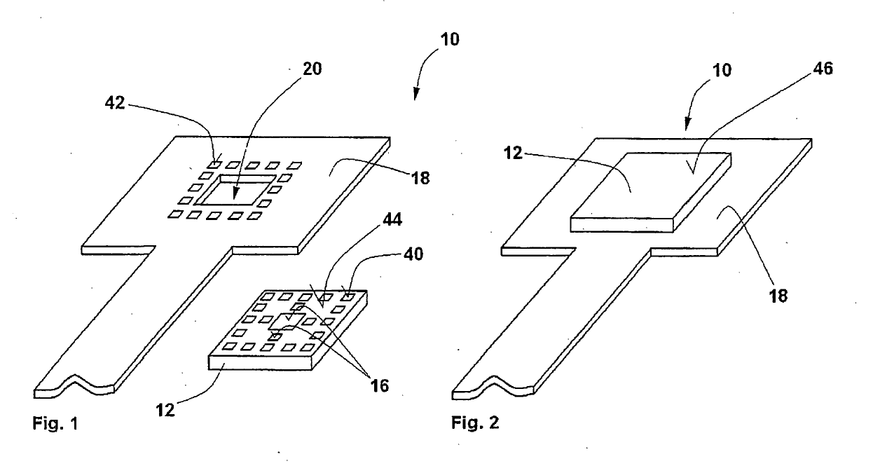

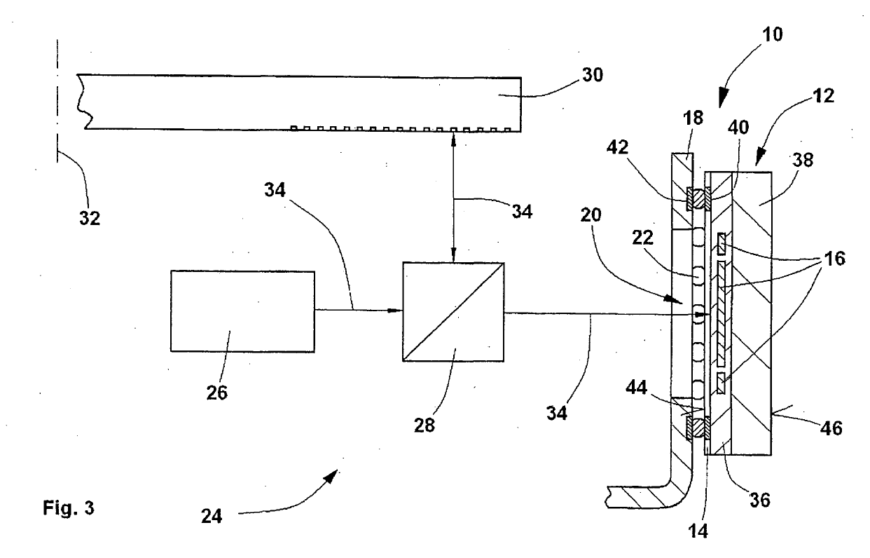

A sensor unit 10, shown in FIGS. 1 and 2 in successive production steps, has a semiconductor element 12 and a contacting unit 18. Semiconductor element 12, as shown in greater detail in FIG. 3, is realized as a layer structure 36 on a carrier structure 38. It has on a surface 44, shown in greater detail in FIG. 1, several light-sensitive areas 16, arranged centrally on surface 44, and a plurality of contact areas 40 disposed circumferentially at the edges. Contacting unit 18 is made of several interconnected film layers (not shown in greater detail) of a polyimide material. In this case, a plurality of traces (not shown in greater detail), some of which extend outward as contact areas 42 on the surface of the contacting unit 18, is disposed between the film layers. Contact areas 42 frame a recess 20 on the edges, which totally penetrates contacting unit 18 and has a substantially square cross section.

Contact areas 40 of semiconductor element 12 and contact areas 42 of contacting unit 18 are matched to one another in such a way that upon placement of surface 44 of semiconductor element 12 on the surface of contacting unit 18, a direct electrical contact between the respective contact areas 40, 42 can be produced. To achieve a reliable electrical connection between contact areas 40 and 42, solder balls 22, shown in greater detail in FIG. 3, are applied to contact areas 40 of semiconductor element 12, said balls which after placement of semiconductor element 12 on contacting unit 18 can be melted on by application of heat and which assure a metallic connection between contact areas 40 and contact areas 42.

As shown in greater detail in FIG. 3, semiconductor element 12 has a carrier structure 38, which is typically made of metal, ceramic, or silicon dioxide. To carrier structure 38, layer structure 36 made of several layers, not shown in greater detail, is applied in which the schematically depicted light-sensitive areas 16 are formed. The light-sensitive areas 16 are connected to contact areas 40 by electrical traces (not shown in greater detail), which extend outward at surface 44 of semiconductor element 12. The remaining surface 44 of semiconductor element 12 is provided with a cover layer 14, made as an antireflection coating and as a mechanical protective coating. Cover layer 14 is provided to protect light-sensitive area 16 and optionally to protect the additional electronic circuits realized on semiconductor element 12 and not shown in greater detail. Moreover, cover layer 14 with its properties as an antireflection coating has the task of passing on the incident light rays as unimpeded as possible to light-sensitive area 16 to enable an advantageous efficiency of sensor unit 10 designed as an optical sensor.

An optical sensor 24, shown schematically in FIG. 3, which is provided with sensor unit 10, has a laser light source 26 that emits a light ray 34. Light ray 34 strikes a semitransparent mirror 28 and is deflected thereby by 90 degrees to strike a surface of an optical data carrier 30. Depending on the information stored in optical data carrier 30, light ray 34 is reflected back in a predefinable manner by optical data carrier 30 again in the direction of semitransparent mirror 28 or is optionally scattered. A back-reflected light ray 34 again strikes semitransparent mirror 28 and is again deflected by 90 degrees to be then able to emerge from semitransparent mirror 28 in the direction of sensor unit 10. Light ray 34 through recess 20 of contacting unit 18 can now strike cover layer 14 of semiconductor element 12 and is relayed from there to light-sensitive area 16. As a result, at least one electrical signal can be generated in semiconductor element 12, which after optional processing in semiconductor element 12 is relayed to contact areas 40. Contact areas 40 enable relaying of the electrical signal to contacting unit 18 and from there to an evaluation device, which is not shown.

A thickness of the merely schematically shown semiconductor element 12 is 25/100 mm, and a thickness of the contacting element is about 18/100 mm. With consideration of the thickness of the solder balls of about 1/10 mm, a total thickness of the cover-free sensor unit of about 55/100 mm is achieved, so that sensor unit 10 occupies only a small structural space in the direction of incident light ray 34. A circumferential edge of contacting element 18, which protrudes in the lateral direction over the largest surface 44 of semiconductor component 12, is about 2/10 mm, so that an especially compact construction of sensor unit 10 in a plane orthogonal to the incident light ray can be realized through the housing-free execution of semiconductor element 12.

Optical sensor 24 can be used for different optical data drives; typical applications are CD drives and DVD drives, which operate with one or more light wavelengths, particularly in the wavelength range from 400 nm to 800 nm.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A sensor unit comprising:
a light-sensitive semiconductor element that has at least one light-sensitive area disposed beneath a light-transmitting cover layer; and
a flat contacting unit that is provided electrically conductive on contact areas of the semiconductor element and is provided with at least one recess, which is formed for incidence of light on the light-sensitive area,
wherein the sensor unit, in an area of the light-sensitive area, is made without a light-transmitting cover.

2. The sensor unit according to claim 1, wherein the semiconductor element is formed without a housing.

3. The sensor unit according to claim 1, wherein the contacting unit is made of an at least substantially non-light-transmitting material.

4. The sensor unit according to claim 1, wherein the contacting unit has a thickness that is smaller than or the same as a thickness of the semiconductor element.

5. The sensor unit according to claim 4, wherein the contacting unit is formed as a flexible printed circuit board, particularly made of a polyimide material.

6. The sensor unit according to claim 1, wherein electrical connections between the semiconductor element and the contacting unit are formed using flip-chip technology or using solder ball technology.

7. The sensor unit according to claim 1, wherein the semiconductor element is encapsulated on a side facing away from the light-sensitive area with a non-light-transmitting potting material with the contacting unit.

8. The sensor unit according to claim 1, wherein the semiconductor element is provided with a multilayer antireflection coating, which is applied firmly bonded and is matched to a range between infrared and blue light waves.

9. An optical sensor for a scanning device of an optical data drive comprising a sensor unit, the sensor unit comprising:
a light-sensitive semiconductor element that has at least one light-sensitive area disposed beneath a light-transmitting cover layer; and
a flat contacting unit that is provided electrically conductive on contact areas of the semiconductor element and is provided with at least one recess, which is formed for incidence of light on the light-sensitive area,
wherein the sensor unit, in an area of the light-sensitive area, is made without a light-transmitting cover.
